(19) United States
(12) Patent Application Publication
(10) Pub. No.: US 2012/0232750 A1
(43) Pub. Date: Sep. 13, 2012

(54) TRANSPORT OF FLUIDS

(75) Inventor: Jim Leigh, Kilsyth (AU)

(73) Assignee: Smart Solutions and Designs Pty Limited, East Melbourne (AU)

(21) Appl. No.: 13/392,087

(22) PCT Filed: Aug. 27, 2010
(86) PCT No.: PCT/AU2010/001105

§ 371 Date: May 22, 2012

(30) Foreign Application Priority Data
Aug. 27, 2009 (AU) 2009904085
Mar. 18, 2010 (AU) 2010901146

(51) Int. Cl. G06F 7/00; F16K 21/18

(52) U.S. Cl. 701/36; 137/391; 701/1

(57) ABSTRACT

This invention concerns the transport of fluids. In particular in a first aspect it concerns a truck fitted with a tank and a fill line to the tank, comprising: An inlet in the fill line configured for connection to a hose that is, in use, connected to a fluid source to change the amount of fluid in the tank. A sensor to make measurements from which the amount of fluid in the tank can be determined. A valve to allow fluid flow through the inlet, both to increase and decrease the amount of fluid in the tank. And a data acquisition device to periodically record sensor measurements and to associate a time and place with each record. In a second aspect the invention concerns a control system for the truck. In a third aspect the invention concerns a control system for a fleet of trucks.

### TECHNICAL FIELD

This invention concerns the transport of fluids. In particular in a first aspect it concerns a truck. In a second aspect the invention concerns a control system for the truck. In a third aspect the invention concerns a control system for a fleet of trucks.

### BACKGROUND ART

The infrastructure of urban areas generally includes a reticulated main water supply network, that reaches every street and building to supply fresh water. Access to mains water is also required by fire services, and fire hydrants are provided at regular intervals throughout the mains network for fire service access. Typically the hydrants can be accessed by a standpipe or a specially designed water hose that is deployed from a fire truck.

There are also a number of other reasons why water might be transported by water trucks. As a result the water authority will generally have a number of filling stations where water trucks are able to fill with fresh water from the mains. A drawback of this arrangement is that the water trucks may find it necessary to travel long distances in order to fill and deliver water.

Water trucks are also able to fill from fire hydrants, which can obviously ameliorate the distance that needs to be travelled with a full load of water. However, there is a need to regulate this activity in order to prevent water from being taken without authorisation, and to ensure pressure changes caused within the water mains by the extraction of water at hydrants does not result in damage to the mains pipes.

Many other fluids are transported by trucks, and many of these could benefit from similar regulation.

### DISCLOSURE OF THE INVENTION

In a first aspect the invention is a truck fitted with a tank and a fill line to the tank, comprising:
An inlet in the fill line configured for connection to a hose that is, in use, connected to a fluid source to change the amount of fluid in the tank.
A sensor to make measurements from which the amount of fluid in the tank can be determined.
A valve to allow fluid flow through the inlet, both to increase and decrease the amount of fluid in the tank.
And, a data acquisition device to periodically record sensor measurements and to associate a time and place with each record.

The sensor may be a pressure sensor that measures the instantaneous pressure in the tank. The pressure sensor may be installed inside the tank. The pressure sensor may measure the liquid level in the tank in which case it may be located at the bottom of the tank. Alternatively, or in addition, the pressure sensor may measure the gas pressure in the tank. From a series of pressure sensor reading it is possible to identify movements of fluid into and out of the tank. In this case, the system can operate as a monitoring and reporting system with the valve being controlled manually.

Alternatively, or in addition, the sensor may be a flow meter in the fill line which measures flow, either way, through the inlet. The flow meter may be an ultrasonic type flow meter fitted around the outside diameter of the inlet where there may be two probes. This type of meter measures flow to within 1% accuracy, and it is able to measure flow rate (in litres per minute) as well as total volume.

In any event the sensor may be located and designed to ensure it is tamper proof, or tamper evident.

Furthermore, the sensor may periodically report its readings to the data acquisition device. The sensor may periodically provide its readings even when the tank is empty; which provides an integrity check. However, disconnection of the sensor may result in there being no further readings; providing an indication that the sensor has been tampered with.

The inlet will typically be configured with a standard fitting to attach to a hose, such as in the case of water, a fire hose.

A backflow valve may be located downstream of the inlet to prevent any reverse flow from the tank during filling, an RPZ backflow valve is preferred. When the truck is being used to transport water the backflow valve will prevent pollution of the water main by backflow of dirty water into a hydrant.

The valve that allows fluid flow through the inlet may be a control valve. In this case a control unit may selectively control the operation of the valve. Under the control of the control unit, this valve may open at a controlled and slow rate until a predetermined flow rate is achieved. It may then control the rate of flow to maintain it at a preferred value. When filling nears completion the rate may be slowed at a controlled rate to ensure a smooth closure. This operational cycle avoids pressure hammer and other large pressure changes that could damage the supply pipes (such as water mains) or exacerbate existing leaks.

A computer memory within the control unit may keep a permanent record that identifies the truck to which the control unit is fitted.

The control unit may be programmed for each fill by entering the volume of fluid to be taken, using a keypad. Then the control unit may determine the optimum flow rate for the fill depending on a range of factors such as the supply pressure and the size of the supply conduit, also the size of the fill hose. When 95% of the fill has been taken the control valve may start to be closed to gradually reduce flow.

The data acquisition device stores a record of readings from the sensor(s). Further, it may keep a record of each fill, and drop, event, regardless of whether the tank starts empty or part filled, or whether the tank is completely filled after the fill event. It may record data to enable the volume of each fill to be determined. The sensor may be calibrated to enable such determinations.

The data acquisition device may time stamp each fill event using an onboard clock, and it may location stamp each fill event using data received from a satellite positioning system, such as GPS. Although this will generally be an automatic operation of the unit, it may be manually initiated. The data acquisition device may be housed within the control unit.

A receiving antenna for the satellite positioning system will typically be housed within the control unit which will be sealed to ensure it is tamper proof. Alternatively the receiving antenna may be mounted external to the control unit.

The control unit may also house communications equipment including a transmitter to transmit the record of each fill event to a base station. This transmission may occur in real time, periodically or upon request by the base station.

The control unit may comprise a distinct sub-unit comprising the data acquisition device, GPS receiver and the communications equipment. This sub-unit may be wired into the vehicle ignition system; optionally via a voltage regulator, so that it is powered up when the ignition is turned on. A back-up battery may be included within the control unit to ensure the contents of volatile memory are retained after the ignition has been switched off. This also allows the control unit to transmit a status signal periodically while the truck's ignition is off; providing a check that the control system is still operational.

At the base station there may be a real-time map display showing the current location of all the trucks, together with information about their current load condition and recent changes.

In a second aspect the invention is a control system for a truck fitted with a tank and a fill line to the tank, comprising:
A sensor to make measurements from which the amount of fluid in the tank can be determined.
A control valve to allow fluid flow through the fill line, both to increase and decrease the amount of fluid in the tank.
A control unit to control the operation of the control valve.
And, a data acquisition device to periodically record sensor measurements and to associate a time and place with each record.

In a third aspect the invention is a control system for a fleet of trucks, comprising:
A computer system arranged to receive transmissions from each truck in the fleet showing their current location and load condition, and optionally recent changes. Wherein, the computer system is also arranged to display the location of each truck on an interactive map, and wherein upon selection of a particular truck the map displays that trucks current load condition, and optionally recent changes.

A historical record of the trucks' movements may also be stored so that the position and state of the entire fleet can be retrieved for any particular time and date and displayed in the interactive map.

### BRIEF DESCRIPTION OF THE DRAWINGS

An example of the invention will now be described with reference to a water truck and the accompanying drawings, in which:

FIG. 1 is a schematic diagram of a water truck including a control unit.

FIG. 2 is a schematic diagram of the control unit.

FIG. 3(a) is an example of the map display for the base station computer system, showing a ‘fill’ and a ‘drop’ event. FIG. 3(b) is an example of the map display for the base station computer system, showing the locations of hydrants.

FIG. 4 is a schematic diagram of an alternative arrangement of the control unit, sensor and a data acquisition and communications device; for use where a control valve is not used.

### BEST MODES OF THE INVENTION

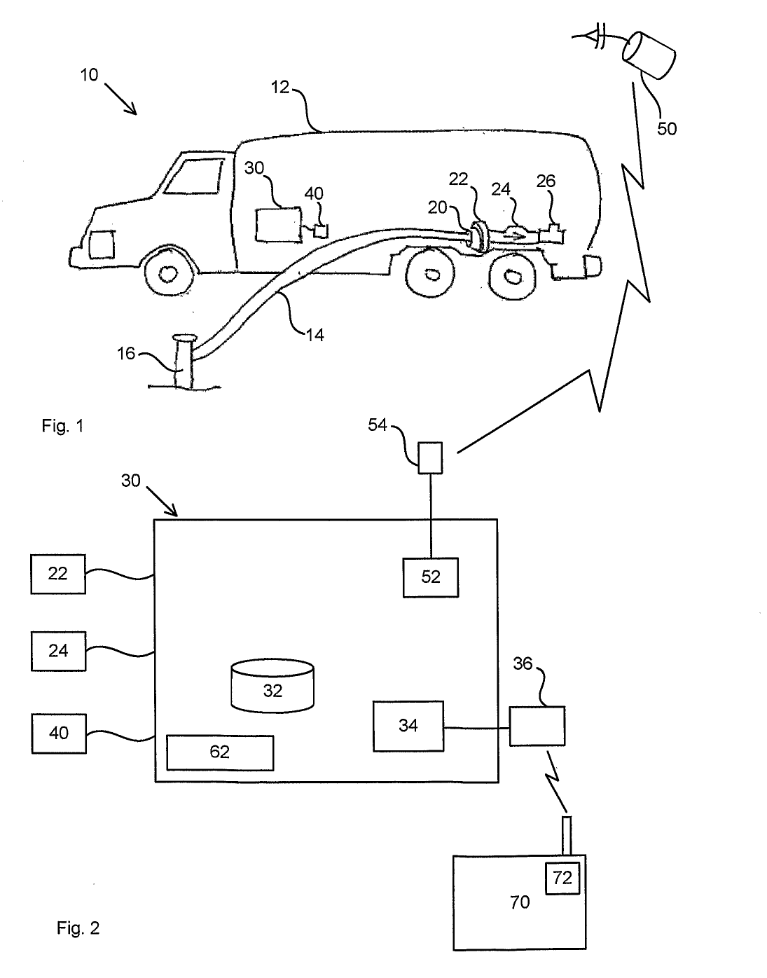

Referring first to FIG. 1, water truck 10 has a water tank 12 and a fill line 14 for filling the tank from a fire hydrant 16. On-board the truck there is a control unit 30.

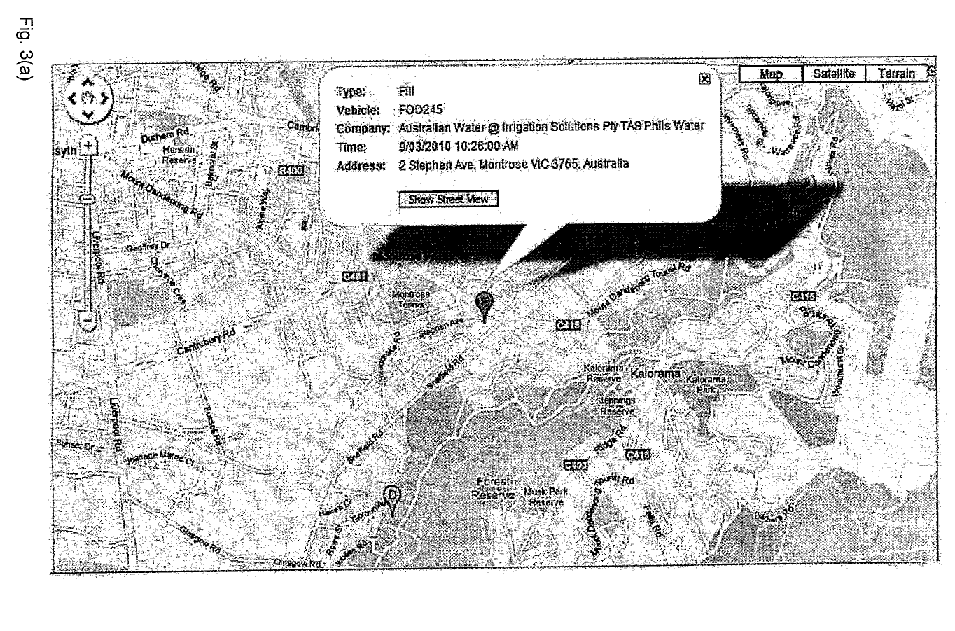

Referring now to FIG. 2, the fill line 14 is attached to an inlet 20 configured for the attachment of a fire hose. Around the inlet 20 is an ultrasonic type flow meter 22 to measure flow of water into the inlet. Next there is a control valve 24 to control the rate of water flow through the inlet to fill the tank 12 (in the direction of the arrow). Following the control valve is a backflow valve 26 to prevent any reverse flow of, possibly dirty, water into the hydrant 16. The control valve 24 controls the rate of water flow into the tank. Finally a control unit 30 controls the operation of the control valve 24, records each filling event and associates a time and place with each record.

In use the control valve 24, under the control of the control unit 30, will operate to fill the tank 12. The control unit 30 may be programmed for each fill by entering the volume of water to be taken using a keypad (not shown). Then the control valve 24 will open at a controlled and slow rate until a predetermined flow rate is achieved. It will then control the rate of flow to maintain it at the preferred value. When filling reaches 95% of completion the rate is slowed at a controlled rate to ensure a smooth closure. This operational cycle avoids water hammer and other large pressure changes that could damage the mains pipes or exacerbate existing leaks.

A separate pressure sensor 40 (see FIG. 1) is fitted to the truck to measure the water level at the level of the bottom of the tank 12. This sensor 40 is able to continuously monitor the level of water in the tank and periodically report its readings to the control unit 30.

A computer memory 32 within the control unit 30 keeps a permanent record of the identity of the truck to which the unit is fitted. It will also store a record of pressure readings from the pressure sensor 40 within the tank. Further, it will keep a record of each fill event, regardless of whether the tank starts empty or part filled, or whether the tank is completely filled. It will record data from the flow meter 22 or pressure sensor 40, or both, to enable the volume of each fill to be determined.

The control unit 30 will time stamp each fill event using an onboard clock, and it will location stamp each fill event using a data received from a satellite positioning system 50, such as GPS. A modem 52 and for the satellite positioning system will typically be housed with the control unit which will be sealed to ensure it is tamper proof. The receiving antenna 54 is externally mounted.

The control unit may also monitor discharge events, for instance using the pressure sensor 40.

The control unit 30 and valve 24 may be powered from the truck's electrical system 60, and a back-up battery 62 may be included within the control system to ensure the contents of volatile memory are retained after the ignition has been switched off. The modem may be arranged to turn off two to three hours after the trucks ignition has been turned off so that it doesn't drain the battery unnecessarily.

The control unit 30 may also include a data acquisition device 34 that handles the capturing and logging of vital data and the communications of data to the servers. Device 34 also includes transmitter 36 to enable data to be transmitted to a base station 70, either periodically or in real time. This may useful for scheduling and routing of a fleet of water trucks. It will also support a billing system to charge for the water taken from the mains.

The control unit 30 regulates the power supplied to the sensor 40 and data acquisition device 34 to ensure the accuracy of the system by providing a constant regulated voltage thus filtering fluctuations from the vehicles electrical system.

The control unit 30 controls when power is supplied to the data acquisition device 34 and sensor 40 by delaying the power output supply of power from the control unit for 10 seconds after a vehicles ignition has been switched on. The control unit continues to supply power to the sensor and the data acquisition device 34 for a time period of three hours after the positive voltage signal from the ignition wire connected to the vehicles ignition system is removed. After the three hour time period the control unit ceases to output power to the sensor and data acquisition device 34.

Another function of the control unit 30 is to perform an overall system health check. During the sleep state, that is, when the control unit is not outputting power to the sensor 40 or data acquisition device 34 the control unit 30 wakes up, that is supplies power to the sensor 40 and data acquisition device 34, for a period of five minutes every six or twelve hours depending on configuration. This function results in the data acquisition device 34 sending data to the base station 70 over a cellular network, provided by a mobile telecommunications provider.

The data is transmitted at pre programmed time intervals, by the triggering of alarm events programmed into the device, initiated by the operator or from commands sent to the device requesting the data. Commands sent to the device can be in the form of a SMS message containing the command or from the server via the data transmission provider.

The internal memory 32 inside the data acquisition device 34 allows for data to be captured and logged for transmission back to the base station 70 at a later time if the data acquisition device 34 is in a black spot, that is, in an area where communications coverage is not available. Retrieval of logged data not transmitted back to the server due to a black spot is instigated from the data receiving software running on the servers or base station 70.

Various parameters of the data acquisition device 34 are configurable via device setup software. This software is installed on a local PC with restricted access, to set-up and configure the devices.

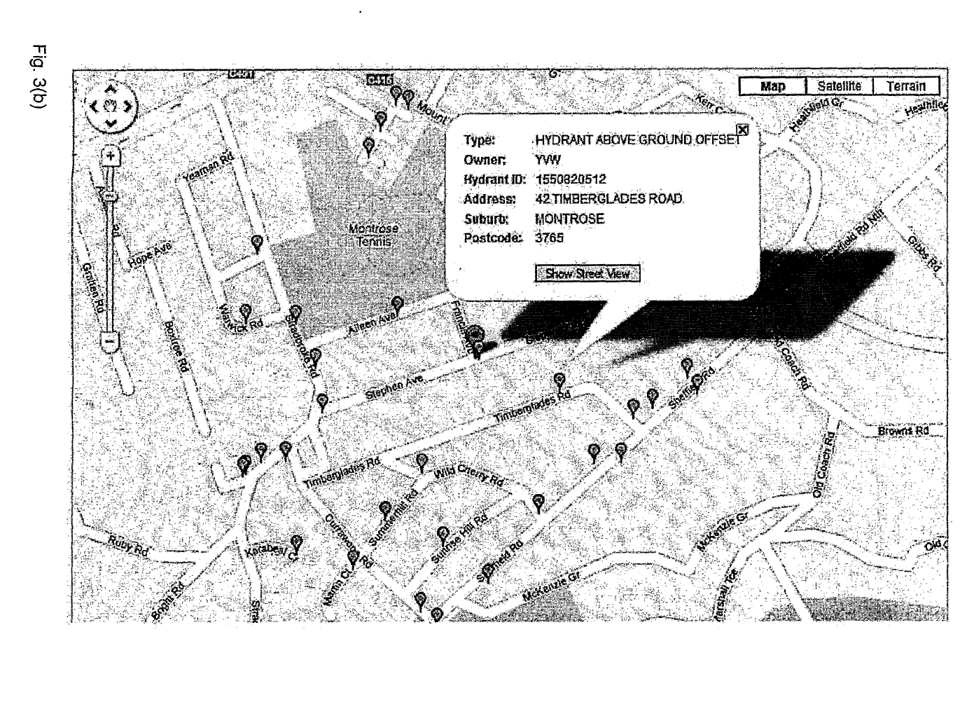

At the base station 70 there may be a real-time map display 72 showing the current location of all the water trucks 10, together with information about their current load condition and recent changes. It may also show available fire hydrants 16. See FIG. 3, where FIG. 3(a) is a map display pinpointing the location of a ‘fill’ event at a hydrant. The hydrant is colour coded and marked with the letter ‘F’ to show that it is being used to fill a tanker and a balloon provides details of the event, truck identity, time and date, and the address of the location. The other marker is also colour coded and marked with ‘D’ to show a drop event. Selecting this marker would open an information balloon displaying similar information but regarding the drop.

FIG. 3(b) shows the map at higher resolution and this map has all the hydrants marked. Selecting a hydrant opens an information balloon that provides details of the type and location of the hydrant.

A software application at the server installation uses the received information to determine the state of the system in each vehicle 10. Through exception reporting, it can then be determined if the system or sensors are functioning correctly, whether the system has been tampered with or if there is a fault with either the sensor 40 or the data acquisition device 34.

There are three servers operating together in this example, a communications server, a data server and a web server. These will now be described in greater detail.

The communication server controls and receives data from the data acquisition device 34. Data is received and transmitted via the TCP or another communications protocol through a specific IP address and port via the internet to/from the cellular network to/from the data acquisition device 34.

The data server is where the majority of the background operations and data analysis is performed using a SQL database solely written and maintained by the Data Collect IT engineers. An SQL database residing on the data server pulls information from the communications server.

This information is then used within the system where various algorithms and other processes are applied to the raw data to supply all the detailed information available to the user via the web based GUI.

For users, the system provides a web based application accessible through any of the popular web browsers. A secure login and permissions based access control allow for different levels of users to access different types of information in the system.

The following information is produced and available from the system by being viewed by the user on screen or compiled into reports or automated reports generated by the system.
Filling of a tank
Emptying of a tank
Time and date stamping
Vehicle location. Current, Live track or History
Location of assets such as fill points and hydrants
Location of filling and emptying of the tanks
System health checks
Billing data based on pricing tables and locations of fills
Map view of assets and vehicles
Authority boundaries displayed ion map view

Installation

The control unit 30, data acquisition device 34 and pressure sensor 40 are all fitted to the vehicle and interconnected with electrical wires during installation. This installed system then provides data to the secure servers at the base station. The data is then processed and made available to users via an online web based application. Only registered users of the system have access to the online application, via a secure login.

The control unit 30 is wired directly to the vehicles main power source which is usually the main battery, other power sources may be used to supply the control box and operate the system. The control box is connected to the vehicles ignition system by means of a single wire. This wire receives a signal in the form of a positive (+) voltage from the vehicles ignition which acts as the trigger to activate the output of regulated power from the control box to provide power to the sensor(s) 40 and the data acquisition device 34.

The pressure sensor 40 is fitted to the tanker by means of a thread and mating thread located in the tank of the vehicle. Between the sensor and the tank a tamper proof housing base is secured between the two threads. This base accommodates the fitment of the plastic tamper proof cover which is not removable without damage once the connection of the wires is complete.

The sensor 40 is electrically connected with wires to the data acquisition device 34 and the control unit 30. A signal is sent from the sensor 40 to the data acquisition device 34 which relates to the pressure of fluid in the tanker; as the pressure of fluid in the tanker increases, the signal changes. This signal is sent to the server in the form of a numerical value, and it is matched to a table created during the installation and calibration of the system.

Calibration of the system can be carried out during either the filling or emptying of the tanker. The purpose of calibration is to ensure that the true tank volume and sensor reading are accurate at any given liquid level in the tank. A calibrated flow meter is used to meter the volume of water pumped into the tanker and pumped out of the tanker. This volume is recorded and added to the calibration table which is specific to and created for each vehicle. As the water passes through the flow meter a pulse is generated from the meter for every 100 litres. This pulse passes through a hardware interface to a computer which generates a line of data in the calibration table produced by the software running on the calibration computer. The line of data comprises of the current date and time and the sensor reading at the time of the pulse. The resulting table is a series of lines of data, each line signifies 100 litres. The number of lines of data are added up to give the total volume of water into the tanker. An example of this is, 10 lines of data in the calibration table equates to 1000 litres.

This calibration table is stored in an SQL database and is used by the system to match a specific tank level/volume to a specific sensor 40 reading whenever queried for display or for billing purposes.

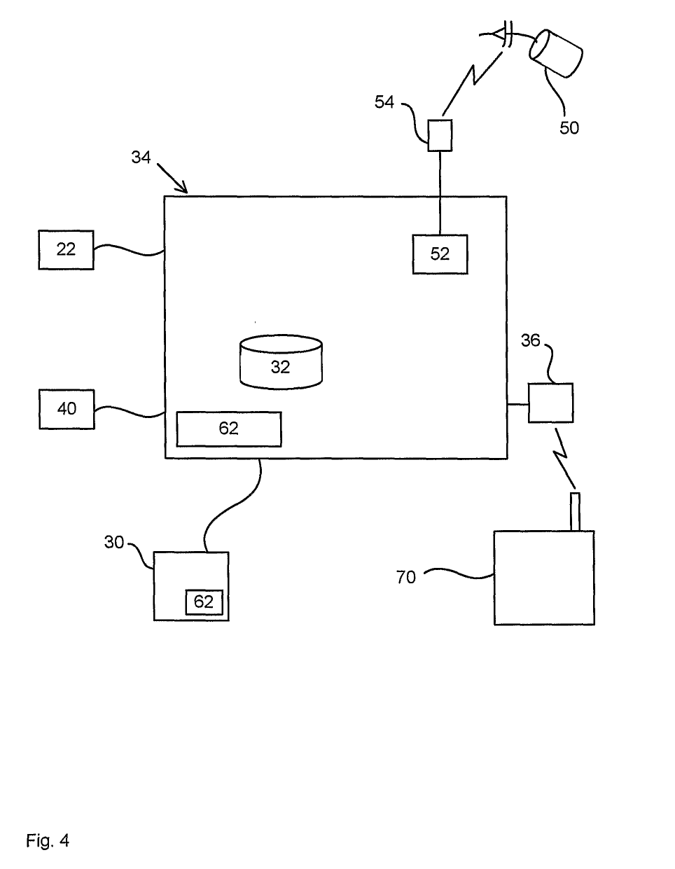

Although the invention has been described with reference to a particular example, it will be readily appreciated that the invention may be performed with a variety of different devices and configurations. For instance, in an alternative arrangement the there need be no control valve 24 to enable the volume of each fill to be determined; see FIG. 4. In this case the sensor 40 and flow meter 22 report directly to the data acquisition and communications device 34.

Device 34 may keep a permanent record of the identity of the truck to which the unit is fitted. It will also store a record of pressure readings from the pressure sensor 40 within the tank. It will keep a record of each fill, and drop, events; it will time stamp each fill event using an onboard clock, and it will location stamp each fill event using data received from the satellite positioning system 50, such as GPS, using a modem 52 and receiving antenna 54 and modem 52 for the satellite positioning system could be housed within the device which will be sealed to ensure it is tamper proof. Initiation of the recording of events will usually be automatic, but may be manually initiated.

### INDUSTRIAL APPLICATION

This invention has wide application besides water. For instance, fuels, whether liquid or gas, waste, effluent.

1. A truck fitted with a tank and a fill line to the tank, comprising:
an inlet in the fill line configured for connection to a hose that is, in use, connected to a fluid source to change an amount of fluid in the tank;
a sensor to make measurements from which the amount of fluid in the tank can be determined;
a valve to allow fluid flow through the inlet, both to increase and decrease the amount of fluid in the tank; and,
a data acquisition device to periodically record sensor measurements and to associate a time and a place with each record.

2. A truck according to claim 1, wherein the sensor is a pressure sensor that measures an instantaneous pressure of liquid or gas, or both in the tank.

3. A truck according to claim 1, wherein the sensor is a flow meter in the fill line which measures flow, either way, through the inlet.

4. A truck according to claim 3, wherein the flow meter is an ultrasonic type flow meter fitted around an outside diameter of the inlet where there are two probes.

5. A truck according to claim 1, wherein the sensor is located and designed to ensure the sensor is tamper proof, or tamper evident.

6. A truck according to claim 1, wherein the sensor periodically reports said measurements to a control unit.

7. A truck according to claim 1, wherein a backflow valve is located downstream of the inlet to prevent any reverse flow from the tank during filling.

8. A truck according to claim 1, wherein the valve that allows fluid flow through the inlet is a control valve that is selectively controlled by a control unit.

9. A truck according to claim 8, wherein under the control of the control unit, the control valve is opened at a controlled and slow rate until a predetermined flow rate is achieved; then the rate of flow is controlled to maintain the rate of flow at a preferred value, and finally the rate is slowed at a controlled rate to ensure a smooth closure.

10. A truck according to claim 9, wherein the control unit is programmed for each fill by entering the volume of fluid to be taken, using a keypad; then the control unit determines an optimum flow rate for the fill.

11. A truck according to claim 8, wherein the control unit keeps a permanent record that identifies the truck to which the control unit is fitted.

12. A truck according to claim 11, wherein the data acquisition device stores the record of sensor measurements from the sensor.

13. A truck according to claim 12, wherein the data acquisition device also keeps a record of each fill, and drop, event.

14. A truck according to claim 13, wherein the data acquisition device time stamps each fill event using an onboard clock, and the data acquisition device location stamps each fill event using data received from a satellite positioning system.

15. A truck according to claim 14, wherein a receiving antenna for the satellite positioning system is housed within the control unit which is sealed to ensure the control unit is tamper proof.

16. A truck according to claim 15, wherein the control unit also comprises communications equipment including a transmitter to transmit the record of each fill event to a base station.

17. A truck according to claim 16, wherein the control unit comprises a distinct sub-unit comprising the data acquisition, GPS receiver and the communications equipment, and this sub-unit is wired into a vehicle ignition system of the truck optionally via a voltage regulator, so that the control unit is powered up when the ignition is turned on.

18. A truck according to claim 17, wherein a back-up battery is included within the control unit to ensure the contents of a volatile memory are retained after the ignition has been switched off.

19. A control system for a truck fitted with a tank and a fill line to the tank, comprising:
a sensor to make measurements from which an amount of fluid in the tank can be determined;
a control valve to allow fluid flow through the inlet, both to increase and decrease the amount of fluid in the tank;
a control unit to control the operation of the control valve; and
a data acquisition device to periodically record sensor measurements and to associate a time and a place with each record.

20. A control system for a fleet of trucks, comprising:
a computer system arranged to receive transmissions from each truck in the fleet showing their current location and load condition; wherein the computer system is also arranged to display the location of each truck on an interactive map, and wherein upon selection of a particular truck the interactive map displays that trucks current load condition.

21. A control system according to claim 20, wherein a historical record of the trucks' movements is also stored so that the position and state of the entire fleet can be retrieved for any particular time and date and displayed on the interactive map.

22. A control system according to claim 20, wherein the interactive map also shows information about each truck's current load condition and recent changes, and available fire hydrants.

23. A control system according to claim 20 further comprising a non-transitory computer readable medium storing a software application to use exception reporting to determine if the system or sensors are functioning correctly, whether the system has been tampered with or if there is a fault with either the sensor or the data acquisition device.

24. A control system according to claim 20 able to produce the following information:
filling of a tank;
emptying of a tank;
time and date stamping;
vehicle location: current, live track or history;
location of assets such as fill points and hydrants;
location of filling and emptying of the tanks;
system health checks;
billing data based on pricing tables and locations of fills;
map view of assets and vehicles; and
authority boundaries displayed ion map view.

25. A control system for a truck according to claim 19 further comprising a computer memory within the control unit to keep a permanent record of the identity of the truck to which the unit is fitted, and to store a record of pressure readings from a pressure sensor within the tank.

26. A control system for a truck according to claim 25, wherein the computer memory will also record data from the flow meter or pressure sensor, or both, to enable the volume of each fill to be determined.

27. A control system for a truck according to claim 26, wherein the control unit will time stamp each fill event using an onboard clock, and the control unit will location stamp each fill event using a data received from a satellite positioning system.

28. A control system for a truck according to claim 19, wherein the control unit is powered from the truck's electrical system, and a back-up battery within the control system ensures the contents of memory are retained after an ignition of the truck has been switched off.

29. A control system for a truck according to claim 28, wherein the control unit also includes a data acquisition device and a transmitter to enable data to be transmitted to a base station, either periodically or in real time.

30. A control system for a truck according to claim 29, wherein the control unit continues to supply power to the sensor and the data acquisition device for a time period of hours after the positive voltage signal from an ignition wire connected to the ignition is removed.

31. A control system for a truck according to claim 19, wherein another function of the control unit is to perform an overall system health check.

32. A control system for a truck according to claim 19, wherein during a sleep state wherein the control unit is not outputting power to the sensor or data acquisition device, the control unit wakes up and supplies power to the sensor and data acquisition device, for a period of minutes every six or twelve hours depending on configuration; which results in the data acquisition device sending data to the base station over a cellular network.

33. A control system for a truck according to claim 19, wherein data is transmitted (i) at pre programmed time intervals, (ii) by the triggering of alarm events programmed into the device, initiated by the operator, or from commands sent to the device requesting the data.
